(19) United States
(12) Patent Application Publication
(10) Pub. No.: US 2008/0077059 A1
(43) Pub. Date: Mar. 27, 2008

(54) Massage Machine

(75) Inventors: Daisuke Morikawa, Kyoto (JP); Keisuke Shimizu, Suita (JP); Akihiro Michimori, Nishinomiya (JP); Yoji Kawamoto, Hikone (JP)

Correspondence Address: BACON & THOMAS, PLLC, 625 SLATERS LANE, FOURTH FLOOR, ALEXANDRIA, VA, 22314, US

(73) Assignee: Matsushita Electric Works, Ltd., Osaka (JP)

(21) Appl. No.: 11/902,377

(22) Filed: Sep. 21, 2007

(30) Foreign Application Priority Data
Sep. 26, 2006 (JP) 2006-261467

(51) Int. Cl. A61H 7/00

(52) U.S. Cl. 601/98

(57) ABSTRACT

A massage machine of a chair-type having a backrest part and a seat part includes torso rolling devices provided respectively in the backrest part and the seat part for rolling a torso of a user. Both torso rolling devices of the backrest part and the seat part are designed to operate substantially at the same time and in the same direction. Each of the torso rolling devices includes a rotating member having a width covering a full left and right width of the torso of the user and a drive unit for rotating the rotating member to the left and right. Further, the drive unit includes upheaving mechanisms respectively arranged at left and right rear surfaces of the rotating member for lifting up left and right portions of the rotating member.

### FIELD OF THE INVENTION

The present invention relates to a massage machine and, more particularly, to a massage machine capable of imparting a rolling motion to a torso.

### BACKGROUND OF THE INVENTION

In order for a chair-type massage machine to roll a torso for a relaxing or stretching, it has been contemplated that an oscillating member is provided in a main body of the massage machine to cause an oscillating motion of the oscillating member, as disclosed in Japanese Patent Nos. 2880672 and 3229852, and further that air bags are provided on the left and right sides of a centerline of the massage machine and are repeatedly inflated and deflated in an alternating manner, as described in Japanese Patent Laid-open Application Nos. 2000-51300 and 2003-250851.

When a user sits on a chair-type massage machine having a backrest part and a seat part, the pelvis of the user is supported by both the backrest part and the seat part, although the sitting posture depends on a reclining angle of the backrest part. However, in a conventional chair-type massage machine having a backrest part and a seat part, which can perform a rolling operation for a torso, a rolling mechanism is arranged in either one of the backrest part and the seat part. For this reason, it is impossible for the conventional massage machine to roll a pelvis (torso) in an effective manner.

### SUMMARY OF THE INVENTION

In view of the problems described above in the prior art, the present invention provides a massage machine capable of imparting an effective rolling motion to a pelvis constituting a torso.

In accordance with the present invention, there is provided a massage machine of a chair-type having a backrest part and a seat part, including torso rolling devices provided respectively in the backrest part and the seat part for rolling a torso of a user, both torso rolling devices designed to operate substantially at the same time and in the same direction.

The torso rolling devices may be formed with upheaving mechanisms arranged in left and right portions of the backrest part and the seat part. Alternatively, each of the torso rolling devices may be formed with a rotating member having a width covering a full left and right width of the torso of the user and a drive member for rotating the rotating member to the left and rights.

The rotating member may be supported to rotate about a pivot shaft and the drive member may be adapted to rotate the rotating member about the pivot shaft. Alternatively, the drive member may be upheaving mechanisms respectively arranged in left and right rear surfaces of the rotating member.

The upheaving mechanisms may be formed with air bags driven to be inflated and deflated.

The massage machine may further include: a leg fixing means for fixing legs of the user, the torso rolling devices adapted to impart a rolling motion to the torso in a state that the legs are fixed by the leg fixing means; an arm fixing means for fixing arms of the user, the torso rolling devices adapted to impart a rolling motion to the torso in a state that the arms are fixed by the arm fixing means; a medical treatment element for pressing and treating a back of the user, the torso rolling devices adapted to impart a rolling motion to the torso in a state that the back of the user is pressed by the medical treatment element; and thigh-pressing air bags for inwardly pressing thighs of the user lying on the seat part, the torso rolling devices adapted to roll the torso in synchronism with the pressing operation caused by inflation and deflation of the thigh-pressing air bags.

The backrest part may be freely reclined, in which case the torso rolling devices preferably perform a rolling operation in a state that the backrest part is reclined at an angle of 45 degrees or less with respect to a horizontal plane. The massage machine may further include a leg rest rotatably provided in a front end of the seat part, in which case the torso rolling devices preferably perform a rolling operation in a state that the leg rest is rotated downwardly from a horizontal plane.

In the present invention, torso rolling devices are provided respectively in the backrest part and the seat part so that they can be operated substantially at the same time and in the same direction. Accordingly, it is possible to naturally and effectively roll the pelvis of the user supported on the backrest part and the seat part. This helps improve a lumbago from which the user suffers.

### BRIEF DESCRIPTION OF THE DRAWINGS

The above and other objects and features of the present invention will become apparent from the following description of an embodiment given in conjunction with the accompanying drawings, in which:

FIG. 1 is a schematic perspective view showing an embodiment of the present invention;

FIG. 2 is an explanatory view illustrating a state that a pelvis is supported by a seat part and a backrest part in the embodiment of the present invention;

FIGS. 3A, 3B and 3C are schematic section views illustrating a series of operations performed by the embodiment of the present invention, and FIG. 3D is a schematic section view showing a modified example of the embodiment of the present invention;

FIG. 4 is a block diagram showing the embodiment of the present invention;

FIG. 5 is a schematic perspective view showing another embodiment of the present invention;

FIGS. 6A and 6B are schematic section views illustrating a series of operations performed by the another embodiment of the present invention, and FIG. 6C is a schematic section view showing a modified example thereof;

FIGS. 7A and 7B are schematic section views showing a further embodiment of the present invention;

FIGS. 8A and 8B are schematic section views showing a still further embodiment of the present invention;

FIG. 9 is a schematic section view showing a yet still further embodiment of the present invention;

FIGS. 10A and 10B are schematic perspective views showing an alternative embodiment of the present invention;

FIGS. 11A and 11B are schematic section views showing another alternative embodiment of the present invention;

FIG. 12 is a schematic section view showing a further alternative embodiment of the present invention;

FIGS. 13A and 13B are schematic perspective views showing a still further alternative embodiment of the present invention;

FIG. 14 is a schematic perspective view showing a yet still further alternative embodiment of the present invention;

FIG. 15 is a schematic perspective view showing a modified embodiment of the present invention;

FIG. 16 is a schematic perspective view showing another modified embodiment of the present invention;

FIGS. 17A and 17B are a schematic perspective view and a schematic section view showing a further modified embodiment of the present invention;

FIG. 18 is an explanatory view illustrating an operation of a still further modified embodiment of the present invention; and

FIG. 19 is an explanatory view illustrating an operation of a yet still further modified embodiment of the present invention.

### DETAILED DESCRIPTION OF THE PREFERRED EMBODIMENTS

Hereinafter, embodiments of the present invention will be described with reference to the accompanying drawings.

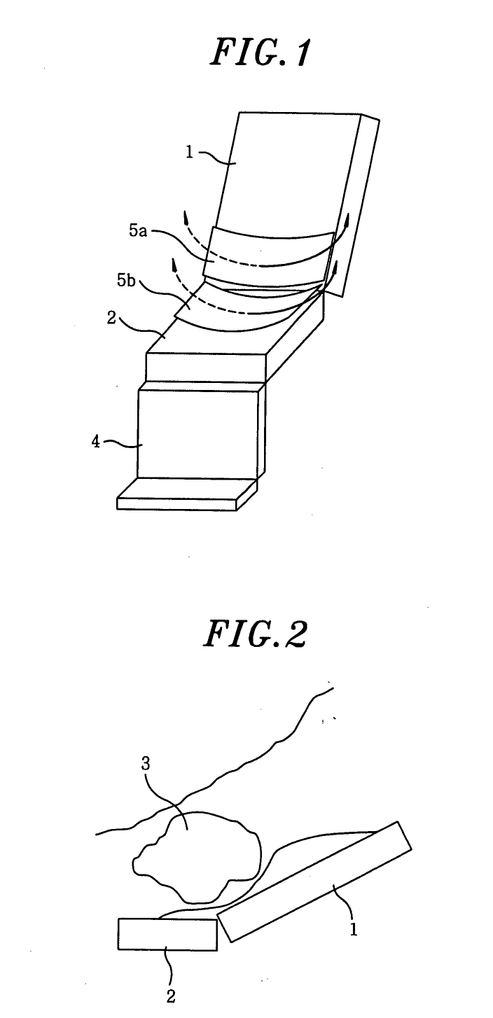

Referring to FIG. 1, a massage machine in accordance with an embodiment of the present invention is of a chair-type including a backrest part 1 and a seat part 2. A leg rest 4 is arranged on a front end side of the seat part 2.

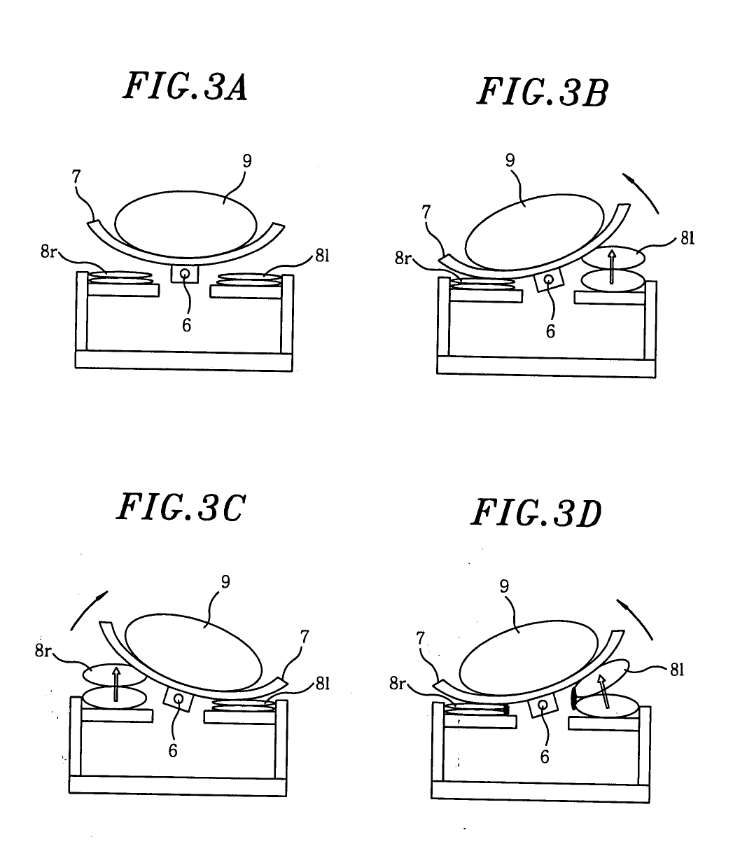

The backrest part 1 and the seat part 2 are respectively provided with torso rolling devices 5a and 5b. As shown in FIG. 3A, each of the torso rolling devices 5a and 5b includes a rotating member 7 for making a rotating motion to the left and right sides about a pivot shaft 6 coinciding with a torso axis, air bags 8r and 8l arranged on left and right sides of the rotating member 7 for causing the rotating member 7 to rotate, and an air supply and discharge device for inflating and deflating the air bags 8r and 8l. The torso rolling devices 5a and 5b are designed to roll a torso of the user by making the rotating member 7 rotate to the left and right sides.

The rotating member 7 has a size great enough to support and roll a pelvis of the user. In this embodiment, the rotating member 7 is formed into a curved shape so that the torso 9 of the user can be supported and rolled with ease. In this case, it is preferred that the surface of the rotating member 7 be made of a material capable of keeping the torso 9 against slip, e.g., a material having a high frictional coefficient. Although the rotating member 7 is placed on a cover of the backrest part 1 or the seat part 2, the rotating member 7 may be placed in the cover of the backrest part 1 or the seat part 2.

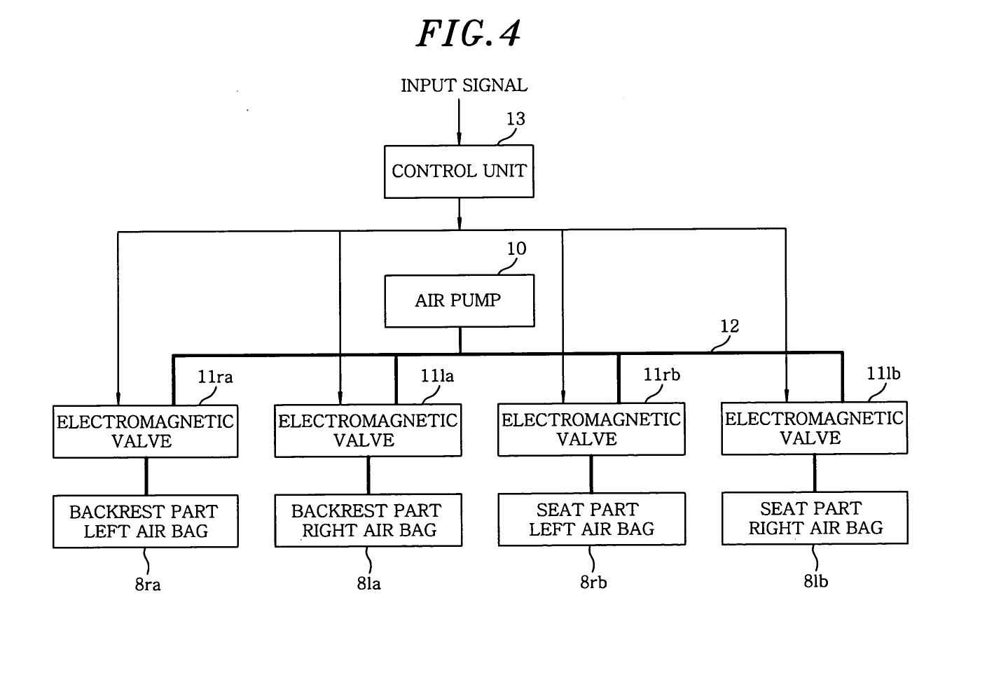

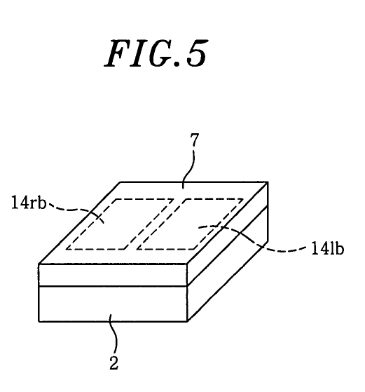

Referring to FIG. 4, the air supply and discharge device includes, e.g., an air pump 10 and electromagnetic valves 11ra, 11la, 11rb and 11lb. Air bags 8ra, 8la, 8rb and 8lb of the backrest part 1 and the seat part 2 are connected to the air pump 10 via the electromagnetic valves 11ra, 11la, 11rb and 11lb and a pipeline 12. In response to input signals, a control unit 13 controls the drive of the air pump 10 and the opening/closing of the electromagnetic valves 11ra, 11la, 11rb and 11lb.

As the user sits on the seat part 2, the pelvis 3 of the user is supported by the rotating member 7 of the seat part 2 and the rotating member 7 of the backrest part 1. Under this state, if the left air bags 8la and 8lb and the right air bags 8ra and 8rb are alternately inflated (or alternately deflated), the rotating members 7 undergo a rotating movement to the left and right sides to thereby roll the torso 9 of the user to the left and the right, as illustrated in FIGS. 3B and 3C. In this embodiment, the left and right air bags 8la, 8lb, 8ra and 8rb are all stacked in two stages. As compared to a single stage air bag configuration, the double stage air bag configuration makes it possible to increase the rolling motion extent of the torso 9 during inflation of the air bags 8la, 8lb, 8ra and 8rb. If the vertically stacked air bags 8r and 8l are tied up together at their inner ends as illustrated in FIG. 3D, the air bags 8r and 8l are inflated upwardly and inwardly to follow the rolling direction. Therefore, use of this configuration is particularly desirable.

The rolling motion set forth above is repeated for a predetermined time period or in a predetermined number of times, thereby providing advantageous effects including alleviation of a lumbago from which user suffers. In this embodiment, the torso rolling devices 5a and 5b for rolling the torso 9 of the user are provided in both the backrest part 1 and the seat part 2, and the torso rolling devices 5a and 5b are operated in the same direction substantially at the same time as described above. Consequently, it is possible to naturally roll the entire pelvis 3 of a user. Alternatively, the torso rolling devices 5a and 5b of the backrest part 1 and the seat part 2 may be configured such that they do not start their operations exactly at the same time. For example, the torso rolling device 5b of the seat part 2 that receives a heavier load may first start its operation and then the torso rolling device 5a of the backrest part 1 may start its operation.

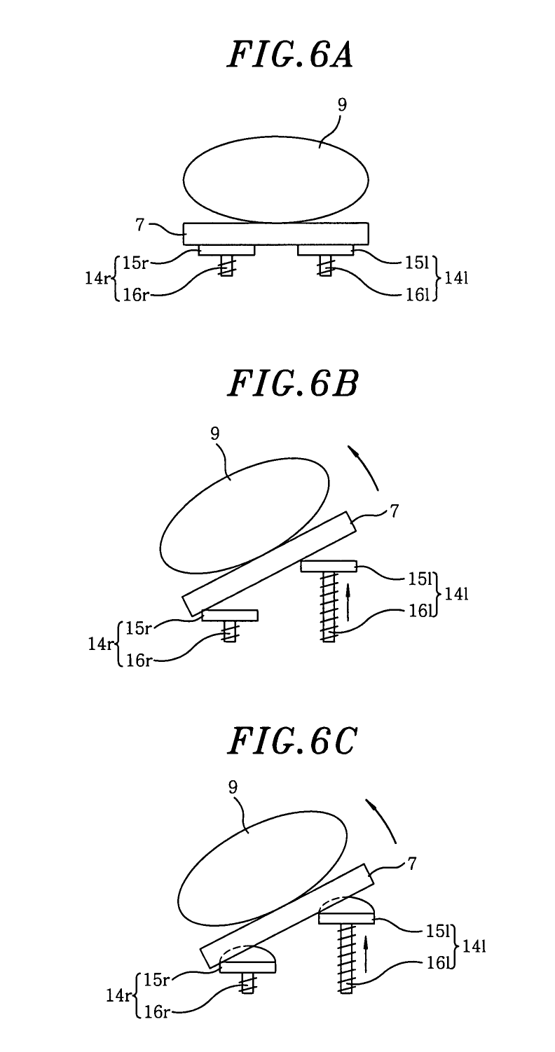

FIGS. 5 and 6A to 6C shows another embodiment of the present invention. In this embodiment, each of the torso rolling devices 5a and 5b arranged in the backrest part 1 and the seat part 2 includes a tabular rotating member 7 having a width great enough to support and roll the torso 9 and upheaving mechanisms 14r and 14l arranged on the left and right rear surfaces of the tabular rotating member 7 for alternately lifting up the left and right portions of the tabular rotating member 7 and consequently making a rotating motion thereof. The upheaving mechanisms 14r and 14l include support plates 15r and 15l and electrically powered extensible and contractible mechanisms 16r and 16l well-known in the art, the extension and contraction operations of which are controlled by the control unit 13 (see FIG. 4). Each of the extensible and contractible mechanisms 16r and 16l includes e.g., a threaded shaft rotatingly driven about its axis and a nut body threadedly coupled to the threaded shaft. Due to absence of the pivot shaft 6, the rotating member 7 rolls as it is lifted up. This makes the user have a feeling that the torso 9 is rolled and stretched.

In this embodiment, the right upheaving mechanism 14r is moved downwardly to lower down the right side of the rotating member 7 at the moment when the left side of the rotating member 7 is lifted up by the left upheaving mechanism 14l, and the left upheaving mechanism 14l is moved downwardly to lower down the left side of the rotating member 7 at the moment when the right side of the rotating member 7 is lifted up by the right upheaving mechanism 14r. Alternatively, after the left side of the rotating member 7 has been be lifted up and lowered down to an initial position, the right side of the rotating member 7 may be lifted up and lowered down. As a further alternative, the upheaving mechanism may be arranged at one of the left and right sides of the rotating member 7 so that the rotating member 7 can make a rotating motion to the left and right sides as the electrically powered extensible and contractible mechanism of the upheaving mechanism is extended and contracted from an initial position.

If a foamed material such as urethane foam is used as the rotating member 7, it is possible to provide a support adapted to to the body. In the present embodiment, the rotating member 7 may be configured to have a curved top surface as presented in the preceding embodiment. This configuration is preferred in that it reduces the burden acting against the torso 9. It is also preferred that the rotating member 7 be made of an elastic material or a low repulsion material. As illustrated in FIG. 6C, the support plates 15r and 15l may preferably have a round top surface.

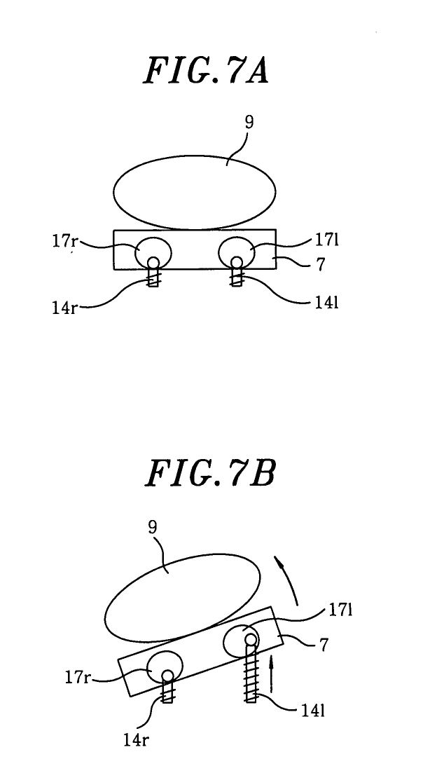

FIGS. 7A and 7B show a further embodiment of the present invention. In this embodiment, the upheaving mechanisms 14r and 14l each include the electrically powered extensible and contractible mechanism 16 (see FIG. 6) well-known in the art and are respectively connected to the left and right sides of the rotating member 7 through eccentric cams 17r and 17l. As the left and right upheaving mechanisms 14r and 14l are alternately extended, the rotating member 7 makes a rotating motion to the left and right sides.

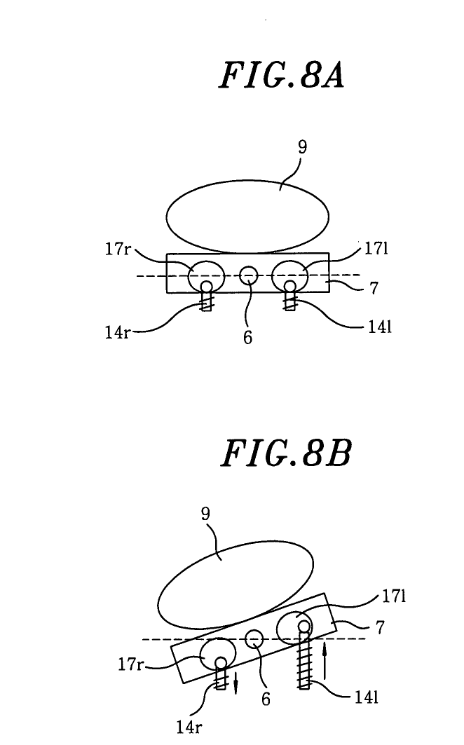

As shown in FIGS. 8A and 8B, the rotating member 7 may be supported at its transverse center by means of a pivot shaft 6. In this case, one of the left and right upheaving mechanisms 14r and 14l is extended when the other is retracted, thereby causing the rotating member 7 to rotate to the left and the right sides. While the rotating member 7 rotates about its left or right end portion in the embodiment shown in FIGS. 7A and 7B, the rotating member 7 makes a rotating motion about the pivot shaft 6 in the embodiment illustrated in FIGS. 8A and 8B, so that a user may have a different feeling between the two configurations.

Further, the position of the pivot shaft 6 is not limited to the transverse center of the rotating member 7 but may be arbitrarily selected. The upheaving mechanism may be arranged on only one of the left and right sides of the rotating member 7 so that the rotating member 7 can make a rotating motion to the left and the right as the electrically powered extensible and contractible mechanism of the upheaving mechanism is extended and contracted from and to an initial position. In the present embodiment, the top surface of the rotating member 7 that receives the torso 9 may be configured to have a curved shape. This configuration is preferred in that it reduces the burden acting against to the torso 9. It is also preferred that the rotating member 7 be made of an elastic material or a low repulsion material.

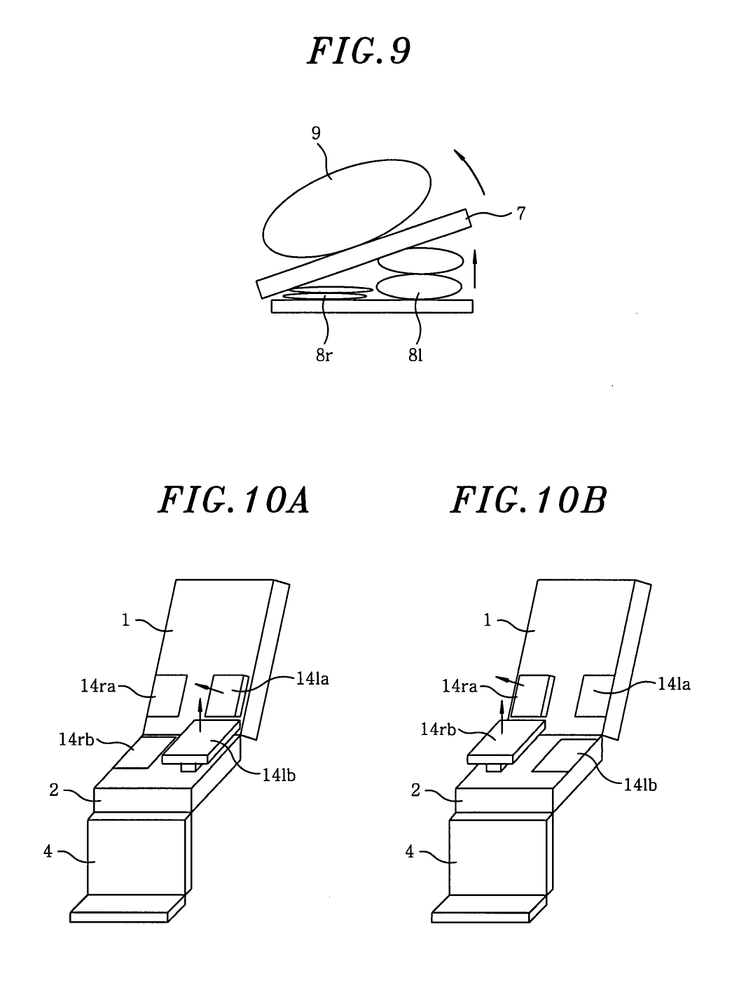

Furthermore, the rotating member 7 not supported by the pivot shaft 6 may be made to rotate to the left and right sides by means of air bags 8r and 8l arranged on the left and right rear surfaces of the rotating member 7. This embodiment is shown in FIG. 9.

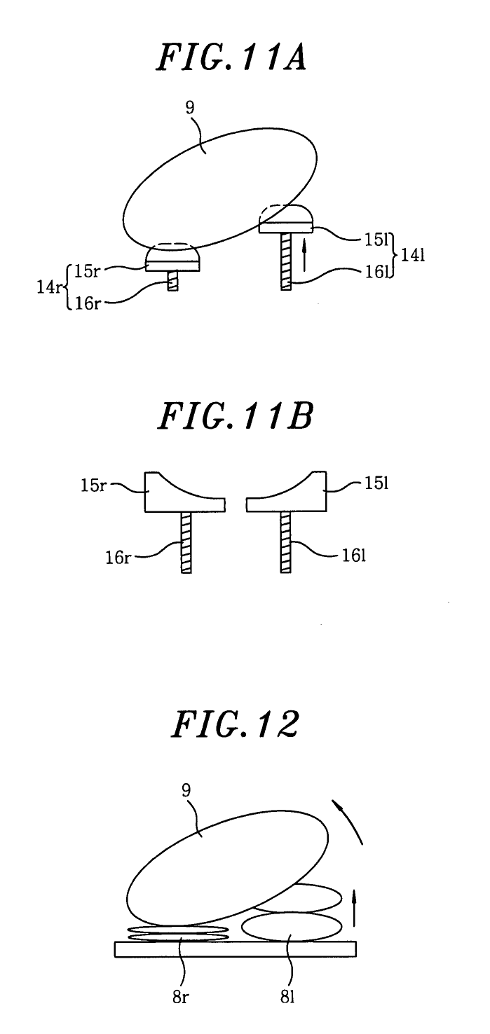

In addition, as illustrated in FIGS. 10A, 10B, 11A and 11B, the torso rolling devices 5a and 5b may include only the left and right upheaving mechanisms 14r and 14l and, without intervention of the rotating member 7, the left and right portions of the torso 9 of a user may be alternately lifted up by the left and right upheaving mechanisms 14r and 14l to impart a rolling motion to the torso 9. In this case, the body is directly supported by the support plates 15r and 15l. Therefore, the portions of the support plates 15r and 15l that contact the body are formed into a convex or concave shape as illustrated in FIGS. 11A and 11B or made of an elastic material or a low repulsion material. This configuration is preferred in that it reduces the burden acting against the torso 9.

In either case, the left and right portions of the torso 9 are alternately lifted up by the left and right upheaving mechanisms 14r and 14l arranged in the backrest part 1 and the seat part 2, so that a rolling motion is imparted to the torso 9. It is preferred that the support plates 15r and 15l be placed inside the covers of the backrest part 1 and the seat part 2. Further, one of the left and right sides of the backrest part 1 and the seat part 2 may be kept lower than the other and the upheaving mechanism may be arranged on the lower side in such a manner that the upheaving mechanism are normally maintained flush with the higher side surfaces of the backrest part 1 and the seat part 2. Despite absence of the rotating member 7 in the present embodiment, this makes it possible to roll the torso 9 to the left and right sides by extending and retracting the upheaving mechanism arranged only on one side surface of the backrest part 1 and the seat part 2.

As shown in FIG. 12, alternatively, the torso 9 may be directly rolled to the left and right sides by use of left and right air bags 8r and 8l. In this case, it becomes possible to roll the torso 9 with a simplified configuration and also possible to make the user enjoy a soft operation feeling. Furthermore, air massage can be performed by arbitrarily inflating and deflating the air bags 8r and 8l of the backrest part 1 and the seat part 2. As a further alternative, the upheaving mechanisms 14r and 14l may be arranged at one of the backrest part 1 and the seat part 2, while arranging the air bags 8r and 8l at the other.

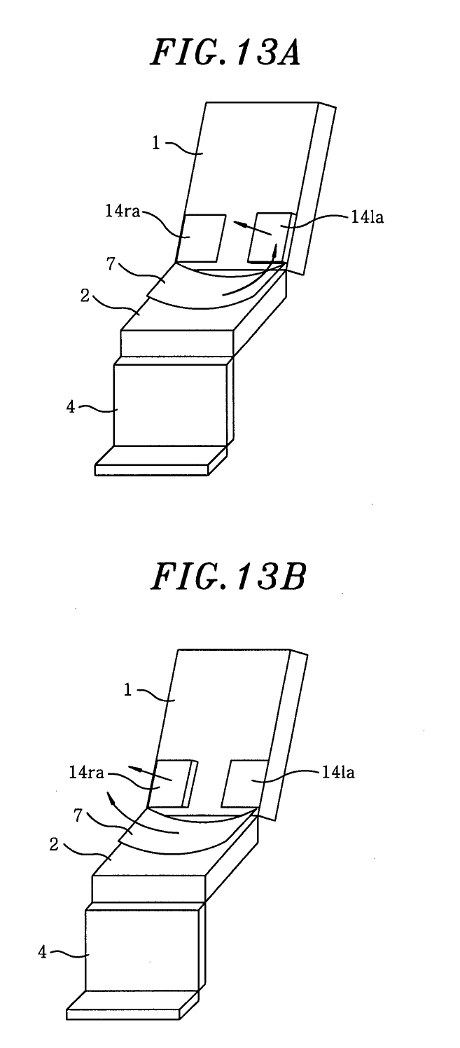

FIGS. 13A and 13B show an embodiment wherein the torso rolling device 5b arranged in the seat part 2 has the rotating member 7 and the torso rolling device 5a arranged in the backrest part 1 is designed to directly lift up the torso 9 without the rotating member 7. In other words, the rotating member 7 capable of supporting the entire width of torso 9 is provided at the seat part 2 that bears a heavy load, thereby allowing the rolling operation to be fully performed, whereas the upheaving mechanisms 14ra and 14la alone are provided in the backrest part 1 that bears a load lighter than that of the seat part 2, consequently allowing the rolling operation to be performed with a simplified configuration.

In this case, a gap can be created at the transverse center of the backrest part 1. Therefore, in case a treatment element available in the conventional massage machine is used in combination, the treatment element can move up to the waist to perform a treatment for the waist. This makes it possible to realize a massage machine capable of not only performing massage by use of the conventional treatment elements but also rolling the torso 9.

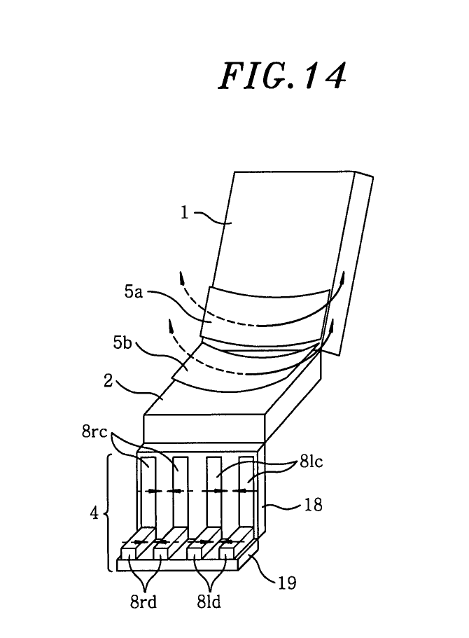

FIG. 14 illustrates an embodiment wherein a leg rest 4 is rotatably arranged at the front end of the seat part 2. The leg rest 4 includes a calf rest 18 for supporting the calves and a footrest 19 for supporting the feet (extending from the ankle to the toes), both of which are interconnected for rotation about a pivot shaft. Air bags 8rc and 8lc are arranged on the left and right side walls of the calf rest 18 to be mutually faced so that the air bags 8rc and 8lc can press and massage the opposite flanks of the calves of the user inserted therebetween. Just like the calf rest 18, air bags 8rd and 8ld are arranged on the left and right side walls of the footrest 19 to be mutually faced so that the air bags 8rd and 8ld can press and massage the opposite flanks of the feet of the user inserted therebetween.

When inflated, the air bags 8rc, 8lc, 8rd and 8ld hold the opposite flanks of the calves and the feet to thereby restrain the calves and the feet. If the operation of rolling the torso 9 is performed in this restraint state, the torso 9 undergoes a rolling motion in an effective manner, thereby making the user have a feeling that the body parts extending from the waist to the legs are stretched. In this case, the torso 9 is rolled to the right side with the left leg restrained and to the left side with the right leg restrained. Alternatively, the torso 9 may be rolled to the left and right sides in a state that the left and right legs are all restrained. As a further alternative, the torso rolling devices 5a and 5b may be operated in a state that only one of the calves and the feet is restrained.

Although air bags are used to restrain the calves and the feet in this embodiment, the present invention is not limited thereto. Any other restraining means may be used as long as it can fix the calves and the feet. Furthermore, it may be possible to restrain the knees and the thighs.

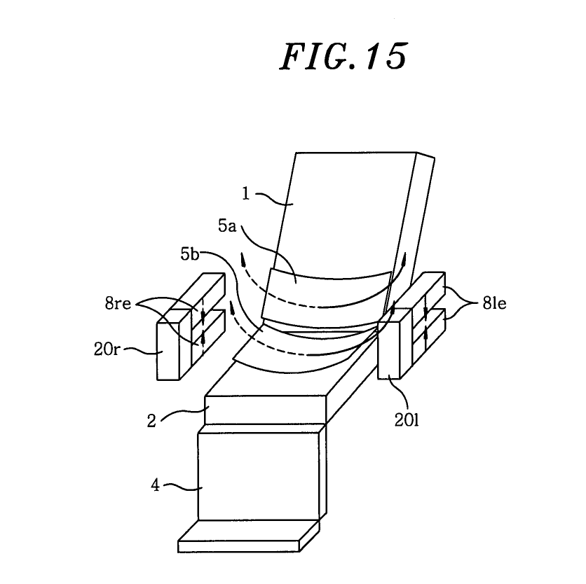

FIG. 15 shows an embodiment wherein armrests 20r and 20l are arranged on the left and right sides of the seat part 2, the armrests 20r and 20l having arm-receiving spaces, and wherein air bags 8re and 8le are arranged in upper and lower internal walls of the arm-receiving spaces in a mutually confronting relationship. In this embodiment, the arms of the user can be pressed and massaged by inflating the air bags 8re and 8le.

When inflated, the air bags 8re and 8le holds the arms therebetween to thereby restrain them. Under this state, if the torso 9 is imparted a rolling motion by simultaneously operating the torso rolling devices 5a and 5b of the backrest part 1 and the seat part 2, the arms are held against release while the pelvis of the user undergoes a rolling motion. This makes the user have a feeling that the body parts extending from the arms to the shoulder joints are stretched.

In this embodiment, the torso 9 is rolled to the left side with the right arm restrained and to the right side with the left arm restrained. Alternatively, the torso 9 may be rolled to the left and right sides in a state that the left and right arms are all restrained. The means for restraining the arms is not limited to the air bags of the illustrated embodiment and other restraining means may be used in place thereof.

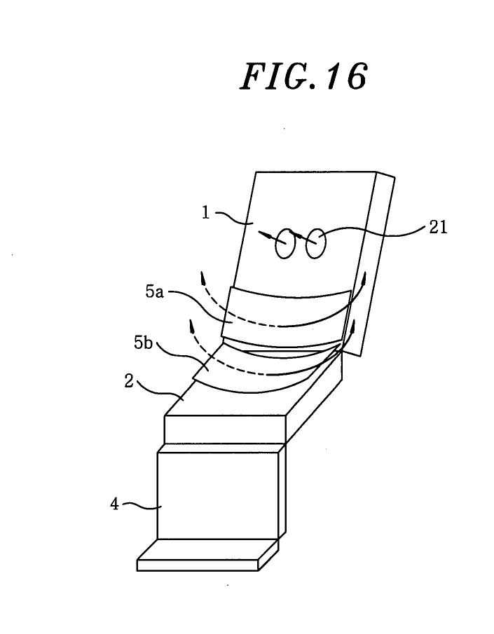

Shown in FIG. 16 is an embodiment wherein a well-known mechanical massage device, including treatment elements 21 movable in an up-and-down direction and a forward-and-backward direction and a control unit (not shown) for operating the treatment elements 21, is arranged in central left and right portions within a central region of the backrest part 1. The treatment elements 21 are mechanically operated to perform punching massage and kneading massage over the body parts of the user extending from the shoulders to the back and the waist.

If the user selects and instructs a rolling operation for the torso 9 by using a manipulation unit (not shown), the control unit 13 governing the operation of the treatment elements 21 allows the treatment elements 21 to move, e.g., between the scapulas of the back of the user, and then apply pressures to the part between the scapulas. At this moment, the thorax of the user is opened wide and the pectoralis major muscle is stretched resultantly. With this state kept in effect, the torso rolling devices 5a and 5b of the backrest part 1 and the seat part 2 are operated at the same time to thereby roll the pelvis 3 (the torso 9) to the left and right sides. The pressing position and the pressing force of the treatment elements 21 vary with the rolling motion, which provides an effect of relaxing the rhomboid muscle lying between the scapulas.

If the torso rolling devices 5a and 5b of the backrest part 1 and the seat part 2 are operated substantially at the same time and in the same direction under a state that the treatment elements 21 remain in contact with the back of the body, it becomes possible to perform a rolling motion of the torso 9 in a stabilized back-supporting posture and also possible to provide an effect of relaxing the back, an effect of stretching the pectoralis major muscle and other effects.

The treatment elements 21 may be allowed to press the back after the torso rolling devices 5a and 5b have started their operations. Alternatively, the torso rolling devices 5a and 5b and the treatment elements 21 may start their operations at the same time. Furthermore, the treatment elements 21 may perform not only a pressing operation but also other well-known operations, such as punching and kneading, available in the massage machine. The treatment elements 21 may be designed to move up and down during the rolling motion of the torso 9.

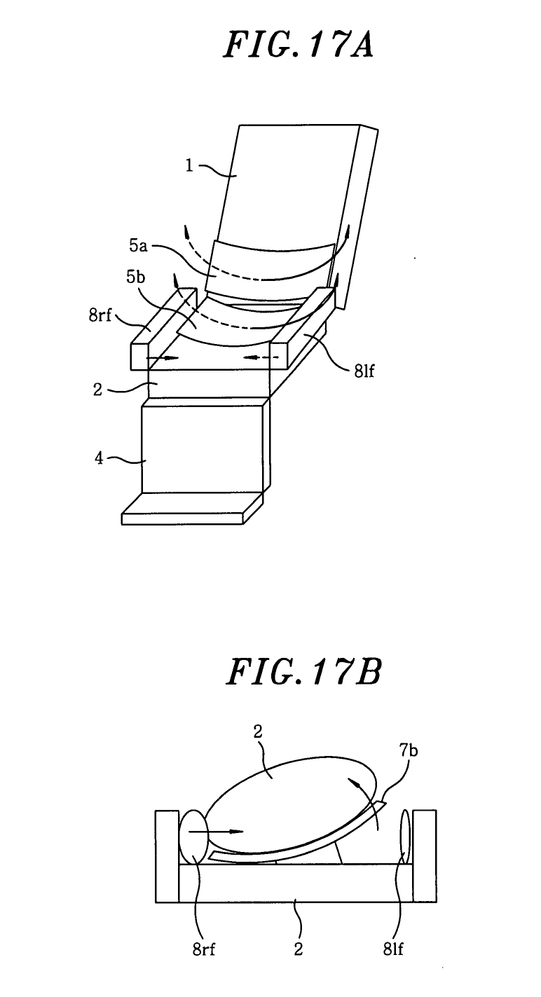

FIGS. 17A and 17B show an embodiment wherein air bags 8rf and 8lf are arranged on the opposite lateral surfaces of the seat part 2. When inflated, the air bags 8rf and 8lf inwardly compress the thighs of the user sitting on the seat part 2. If the right thigh-compressing air bag 8rf is inflated when the torso rolling devices 5a and 5b of the backrest part 1 and the seat part 2 roll to the right side and if the left thigh-compressing air bag 8lf is inflated when the torso rolling devices 5a and 5b of the backrest part 1 and the seat part 2 roll to the left side, displacement of the torso 9 is reduced during its rolling motion. This makes it possible to effectively and naturally roll the torso 9.

In a massage machine of the type that can recline the backrest part 1 in an electrically or hydraulically controlled manner, it is desirable that, upon selection and instruction of a torso rolling operation, the control unit 13 reclines the backrest part 1 at an angle of 45 degrees or less with respect to a horizontal plane prior to starting the rolling motion of the torso 9, as illustrated in FIG. 18.

In the conventional massage machine, massage is usually exercised in an intermediate posture between an upright sitting posture and a half-reclined sitting posture. The half-reclined sitting posture refers to a posture in which the upper half of the body is raised a little, namely at an angle of about 15 to 45 degrees, from a fully reclined posture. The half-reclined sitting posture is known to ease the burden acting against the lumbar vertebras. The burden acting against the lumbar vertebras during the rolling motion can be lessened by performing the rolling motion in a state that the backrest part 1 is further reclined from a normal massage position to thereby achieve the half-reclined sitting posture as illustrated in FIG. 18. Furthermore, this helps remove a stuffy feeling in the abdominal region and assists in dispersing a body pressure and consequently preventing an excessive load from being applied to the waist or the stomach. Moreover, as compared to a back-raised posture, it is easy to naturally roll the pelvis.

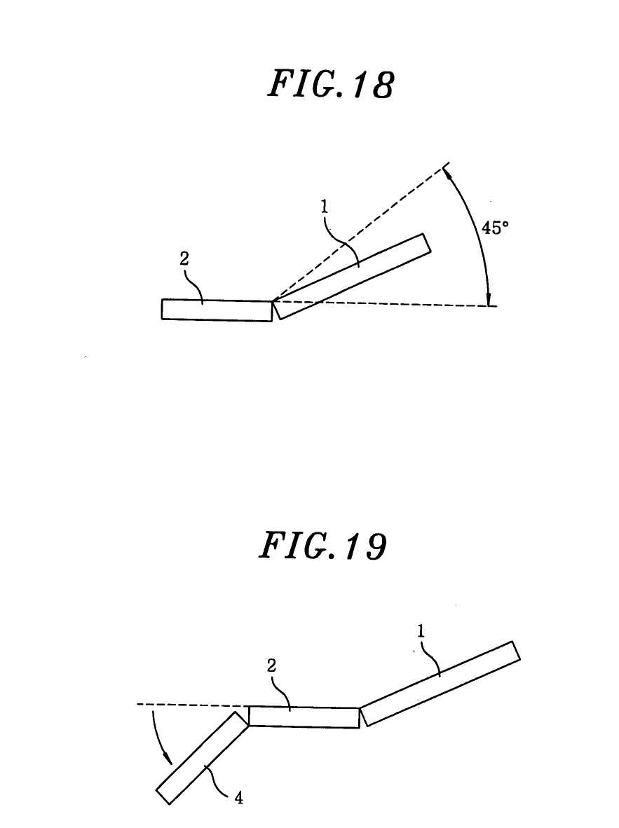

In a massage machine of the type that can electrically or hydraulically rotate the leg rest 4, it is desirable that the leg rest 4 is rotated downwardly from a horizontal plane as illustrated in FIG. 19, in addition to the backrest part 1 being reclined at an angle of 45 degrees or less with respect to the horizontal plane. The reason is that the lumbar vertebras are less burdened in a posture in which the hip joints and the knee joints are curved with the upper half of the body being raised a little bit. If the torso rolling devices 5a and 5b of the backrest part 1 and the seat part 2 are simultaneously operated in the state noted above to thereby roll the torso 9 to the left and right sides, it is possible to impart a rolling motion to the torso 9 without burdening the lumbar vertebras. In a massage machine of the type wherein the seat part 2 is tiltable, the burden acting against the lumbar vertebras can be desirably lessened by keeping the front portion of the seat part 2 higher than the rear portion thereof.

With respect to the amount of the torso 9 of the user rolled by the torso rolling devices 5a, it is not mandatory that the torso 9 be rolled by a constant rolling amount at all times. It is preferred that an operation time detector for detecting the operation time of the torso rolling devices 5a and 5b be provided so that the time period for keeping the torso 9 in a rolled state and the rolling amount can be changed based on the operation time detected by the operation time detector. For example, if the rolling cycle time counted from a startup time is increased step by step and the rolling amount is increased gradually, it becomes possible to impart a safe rolling motion to a person suffering from a reduced physical flexibility, e.g., a person of advanced age.

Furthermore, if the rolling cycle time is reduced step by step from a state of long rolling cycle time and great rolling amount to an end of the rolling operation, it is possible to provide a cool-down effect and hence to lessen the burden to the user. In case air bags are used in the torso rolling devices 5a and 5b, the rolling operation amount may be controlled either by controlling the air bag pressure with a pressure sensor that detects the pressure within the air bags or by using the information on the rolling cycle time and the air bag pressure in combination.

Furthermore, when the torso rolling devices 5a and 5b have reached a predetermined rolling amount, it is preferred that the torso rolling devices 5a and 5b are kept in that state for a while. In other words, after performing a right rolling operation for a predetermined time period, the torso rolling devices 5a and 5b stop their rolling operation for a specified time period and keep the torso in the right-rolled state. The torso rolling devices 5a and 5b are then returned back to the original state. Subsequently, after performing a left rolling operation for a predetermined time period, the torso rolling devices 5a and 5b stop their rolling operation for a specified time period and keep the torso in the left-rolled state for a while. Thereafter, the torso rolling devices 5a and 5b are returned back to the original state. By keeping the torso in the rolled state as noted above, it becomes possible to provide an improved stretching effect. The time required for keeping the torso in the rolled state is preferably about 10 to 60 seconds.

The torso rolling devices 5a and 5b are not limited in configuration to the ones illustrated in the foregoing embodiments. Any other device may be used as long as it can roll the torso. For instance, the rotating member 7 may be rotatingly driven about the pivot shaft 6 by means of an electric motor. Furthermore, as is apparent from the foregoing description, the torso rolling device 5a of the backrest part 1 may not be the same as the torso rolling device 5b of the seat part 2, and the rotating member 7 (the support plate) of the backrest part 1 may differ in shape from that of the seat part 2.

While the invention has been shown and described with respect to the embodiments, it is understood by those skilled in the art that various changes and modifications may be made without departing from the scope of the invention as defined in the following claims.

What is claimed is:

1. A massage machine of a chair-type having a backrest part and a seat part, comprising:
torso rolling devices provided respectively in the backrest part and the seat part for rolling a torso of a user, the torso rolling devices designed to operate substantially at the same time and in the same direction.

2. The massage machine of claim 1, wherein the torso rolling devices include upheaving mechanisms arranged in left and right portions of the backrest part and the seat part.

3. The massage machine of claim 1, wherein each of the torso rolling devices includes a rotating member having a width covering a full left and right width of the torso of the user and a drive unit for rotating the rotating member to the left and right.

4. The massage machine of claim 3, wherein the rotating member is supported for rotation about a pivot shaft and the drive unit is adapted to rotate the rotating member about the pivot shaft.

5. The massage machine of claim 3, wherein the drive unit includes upheaving mechanisms respectively arranged at left and right rear surfaces of the rotating member for lifting up left and right portions of the rotating member.

6. The massage machine of claim 2, wherein the upheaving mechanisms include air bags driven to be inflated and deflated.

7. The massage machine of claim 5, wherein the upheaving mechanisms include air bags driven to be inflated and deflated.

8. The massage machine of claim 1, further comprising a leg fixing unit for fixing legs of the user, and wherein the torso rolling devices impart a rolling motion to the torso in a state that the legs are fixed by the leg fixing unit.

9. The massage machine of claims 1, further comprising an arm fixing unit for fixing arms of the user, and wherein the torso rolling devices impart a rolling motion to the torso in a state that the arms are fixed by the arm fixing unit.

10. The massage machine of claims 1, further comprising a treatment element for pressing and treating a back of the user, and wherein the torso rolling devices impart a rolling motion to the torso in a state that the back of the user is pressed by the medical treatment element.

11. The massage machine of claim 1, further comprising thigh-pressing air bags for inwardly pressing thighs of the user lying on the seat part, and wherein the torso rolling devices roll the torso in synchronism with the pressing operation caused by inflation and deflation of the thigh-pressing air bags.

12. The massage machine of claim 1, wherein the backrest part is freely reclined and the torso rolling devices perform a rolling operation in a state that the backrest part is reclined at an angle of 45 degrees or less with respect to a horizontal plane.

13. The massage machine of claim 1, further comprising a leg rest rotatably provided in a front end of the seat part, and wherein the torso rolling devices perform a rolling operation in a state that the leg rest is inclined downwardly from a horizontal plane.
